(19) United States
(12) Patent Application Publication
(10) Pub. No.: US 2007/0170627 A1
(43) Pub. Date: Jul. 26, 2007

(54) Method and device for adjusting the relative position of structural members

(76) Inventors: Ronald Delk, Newport News, VA (US); Michael Payne, Yorktown, VA (US); Mark Weaver, Yorktown, VA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/336,063

(22) Filed: Jan. 20, 2006

(51) Int. Cl. B25B 1/20

(52) U.S. Cl. 269/37

(57) ABSTRACT

A device is provided for positioning a first structural member relative to a second structural member, the second structural member being attractable to a magnetic material. The device comprises a body comprising the magnetic material and having an engagement surface adapted for engagement with and magnetic attachment to a surface of the second structural member. An elongate lever arm having a first lever arm end is connected to the body. A second lever arm end extends laterally outward from the body. The device further comprises a jacking arrangement attached to the second lever arm end. The jacking arrangement has an engagement member adapted for selectively engaging and applying a force to the first structural member to move at least a portion of the first structural member relative to the surface of the second structural member.

### BACKGROUND OF THE INVENTION

This invention relates to tools used to reposition structural elements relative to one another. More particularly, the invention relates to a tool that can be temporarily attached to one structural member to provide leverage for repositioning a second structural member relative to the first.

In various endeavors, articles must be joined together by known means such as welding, gluing, nailing, etc. In many instances, joinder requires that the relative position of the articles be adjusted to achieve a desired configuration. Often, the articles are brought together by hand and temporarily held in the desired configuration by hand or by devices such as, in the case of welding, small pieces of metal temporarily welded to the articles (also known as “fitter dogs”). Thereafter and while the articles are temporarily held together in such manner, the articles are more permanently joined together such as by welding, gluing, nailing, etc. Once the more permanent joinder is accomplished, the persons holding the articles together can discontinue such activity and/or the devices used for holding the articles together may be removed.

The traditional method of joinder of articles requires significant time and resources (man hours and/or equipment), and/or the use of inefficient devices (such as “fitter dogs”) in order to place articles together and maintain such placement until a more permanent joinder by other methods can accomplished.

What is desired is a device for bringing articles into contact with each other in a desired configuration, maintaining that configuration until a more permanent joinder can be accomplished, and subsequently quickly and easily removing the device.

### SUMMARY OF THE INVENTION

An illustrative embodiment of the invention provides a device for positioning a first structural member relative to a second structural member, the second structural member being attractable to a magnetic material. The device comprises a body comprising the magnetic material and having an engagement surface adapted for engagement with and magnetic attachment to a surface of the second structural member. An elongate lever arm having a first lever arm end is connected to the body. A second lever arm end extends laterally outward from the body. The device further comprises ajacking arrangement attached to the second lever arm end. The jacking arrangement has an engagement member adapted for selectively engaging and applying a force to the first structural member to move at least a portion of the first structural member relative to the surface of the second structural member.

An aspect of the invention provides a method of positioning a first structural member relative to a second structural member, the second structural member being attractable to a magnetic material. The method comprises providing an adjustment device comprising a magnetic body having an engagement surface adapted for engagement with and magnetic attachment to a surface of the second structural member. The adjustment device has a lever arm having a first lever arm end connected to the body and a second lever arm end extending laterally therefrom. The adjustment device also has a jacking arrangement attached to the second lever arm end, the jacking arrangement having an engagement member that may be selectively extended to engage and apply a force to the first structural member. The method further comprises magnetically attaching the adjustment device to the second structural member by placing the engagement surface in engagement with the surface of the second structural member. The adjustment device is positioned and oriented so that the second lever arm extends over a surface of the first structural member and so that the engagement member is in a position to engage the surface of the second structural member when extended. The method also comprises extending the engagement member to engage the surface of the first structural member and further extending the engagement member to apply a force to the first structural member sufficient to cause the relative position of at least a portion of the first structural member to change relative to at least a portion of the second structural member.

### BRIEF DESCRIPTION OF THE DRAWINGS

FIG. 1 is a side view of an adjustment device according to an embodiment of the invention;

FIG. 2 is a top view of the adjustment device of FIG. 1;

FIG. 3 is a top view of an adjustment device according to an embodiment of the invention;

FIG. 4 is a side view of the adjustment device of FIG. 3 illustrated in an attachment position;

FIG. 5 is a side view of the adjustment device of FIG. 3 illustrated in an detachment position;

FIG. 6 is a perspective view illustrating the use of an adjustment device according to an embodiment of the invention;

FIG. 7 is a perspective view illustrating the use of an adjustment device according to an embodiment of the invention;

FIG. 8 is a perspective view illustrating the use of an adjustment device according to an embodiment of the invention;

FIG. 9 is a perspective view illustrating the use of an adjustment device according to an embodiment of the invention;

FIG. 10 is a side view of an adjustment device according to an embodiment of the invention; and

FIG. 11 is a side view illustrating the use of the adjustment device of FIG. 10.

### DETAILED DESCRIPTION OF THE INVENTION

The present invention provides a simple adjustment mechanism that may be used for aligning or otherwise manipulating the position of magnetically attractable structural members relative to one another. The invention provides for the temporary attachment of a lever arm to a first structural member in order to provide leverage for a jacking mechanism that can be used to change the relative position of and/or systematically distort a second structural member. The lever arm is attached to an attachment body having a magnetic material or layer incorporated therein. The magnetic material allows the attachment body to be removably attached to one of the two structural members. The jacking mechanism can then be used to change the relative position of the two structural members.

Although the present invention may be used with virtually any type of structural member, it will be understood that it is of particular value in the alignment of the edges of relatively thin structural sheets such as may be required for the purpose of welding such sheets together. In a particular instance, a first sheet may require alignment of a second sheet along an edge that may or may not be a straight line. With a least a portion of both sheets fixed, one or more of the adjustment devices of the invention may be attached to the two sheets so as to align them along the desired edge.

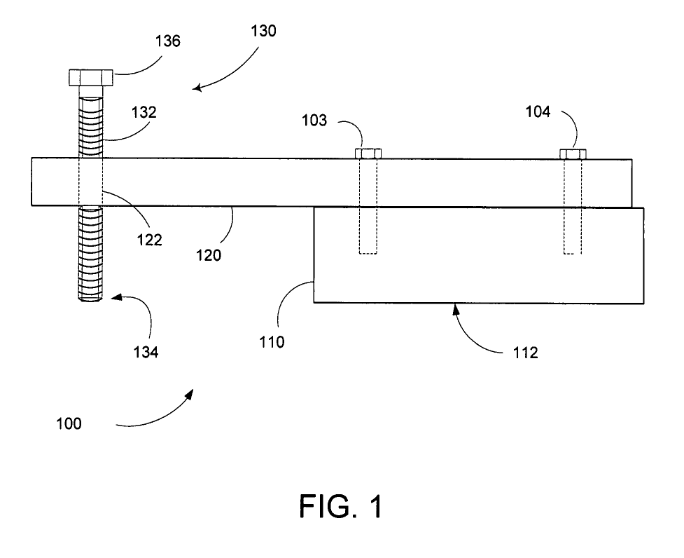

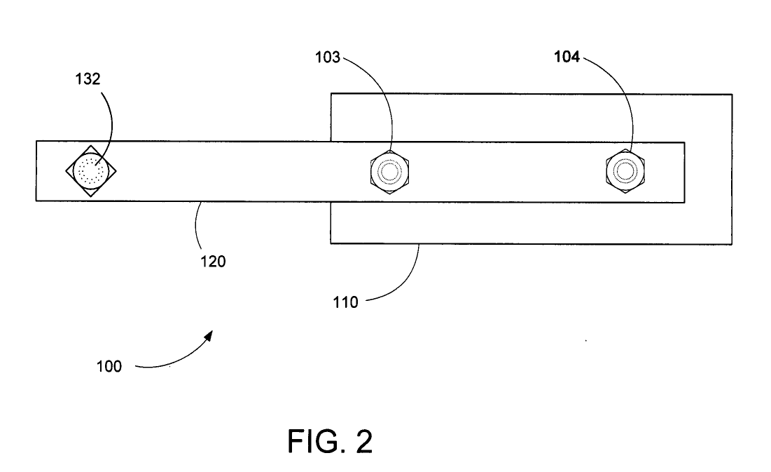

FIGS. 1 and 2 illustrate an adjustment device 100 according to an embodiment of the invention. The adjustment device 100 includes an attachment body 110, a lever arm 120 and a jacking arrangement 130. The attachment body 110 is adapted to temporarily attach the device 100 to a structural member by virtue of magnetic attraction. The lever arm 120 is attached at one end to the attachment body 110 and extends laterally outward therefrom. The jacking arrangement 130 is disposed at or adjacent the free end of the lever arm 120. In use, the attachment body 110 is removably attached to a surface portion of a first structural member in a configuration that allows the free end of the lever arm to extend over a portion of a second structural member. The jacking arrangement 130 is configured for selective engagement with the second structural member. The jacking arrangement 130 is further configured to apply a force to the engaged portion of the second structural member to cause the engaged portion of the second structural member to move relative to the surface portion of the first structural member.

It will be understood that in some instances the entire second structural member may be caused to move relative to the surface portion of the first structural member. In other instances, however, only a portion of the second structural member may be caused to move relative to the surface portion of the first structural member. It will also be understood that one or both of the structural members may be caused to deform as a result of the displacement of the engaged portion of the second member relative to the surface portion of the first structural member.

As will be discussed in more detail hereafter, the jacking mechanism may be configured to apply a compressive (i.e., pushing) force member or a tensile (i.e., pulling) force to the engaged portion of the second structural.

The attachment body 110 may comprise a magnetic material or layer disposed so that the attachment body 110 is attracted to ferrous materials. In some embodiments, the entire attachment body 110 may be formed from a magnetic material. Alternatively, a magnetic material may be uniformly distributed throughout a matrix material. In other embodiments, the attachment body 110 may include a magnetic element held in place by other body materials. In a particular embodiment, the attachment body 110 may be formed with a substantially planar magnetic layer at or beneath the surface of the attachment body 110.

In some embodiments, the attachment body 110 may comprise an electromagnet in communication with a power source. In these embodiments, the magnetic force provided by the attachment body 110 may be selectively turned on to cause the attachment body 110 to engage a surface or turned off to allow the attachment body 110 to disengage from a surface.

The attachment body 110 may be formed with an engagement surface 112 that is configured to engage a portion of a structural member. In certain embodiments, the attachment body 110 and the engagement surface 112 may be configured so as to maximize the area of the engagement surface 112 and, thus, the magnetic force between the attachment body and the structural member to which the device 100 is to be attached. In particular, the contour of the engagement surface 112 may be configured to correspond to the to the surface to be engaged. For example, if the structural member surface has a known curvature, the engagement surface 112 may be formed with the same curvature. In particular embodiments, the attachment body 110 may be formed, at least in part, from a pliable material that conforms to the surface shape of the structural member.

The lever arm 120 is formed as an elongate member attached at one end to the attachment body 110. The lever arm 120 may be formed from any suitable structural material and is configured so as to withstand the forces and moments produced by the jacking arrangement 130 and transfer them to the attachment body 110. The lever arm 120 may be attached to the attachment body using any known fastening mechanism including but not limited to removable fasteners, welds and adhesive bonds. The lever arm 120 may also be integrally formed with the attachment body 110. In the particular embodiment shown in FIGS. 1 and 2, the lever arm 120 is attached to the attachment body 110 by a pair of threaded fasteners 103, 104. In some embodiments, additional holes for accommodating the threaded fasteners 103, 104 may be formed in the lever arm 120 so that the length of the lever arm portion extending from the attachment body 110 may be adjusted.

The jacking arrangement 130 may be disposed adjacent the free end of the lever arm 120. The jacking arrangement 130 may include any mechanism adapted for applying a compressive or tensile force along an axis normal to a surface of the lever arm 120. In the illustrated embodiment, the jacking arrangement 130 includes a bolt or threaded rod 132 disposed through a threaded bore 122 in the lever arm 120 at a desired distance from the attachment body 110. The bolt 132 has a surface engagement portion 134 at its distal end and may have a head 136 configured to assist in rotation of the bolt 132 at its opposite or proximal end. Rotation of the bolt 132 causes the surface engagement portion 134 of the bolt 132 to extend further from the lever arm bore 122 or retract closer to or into the lever arm bore 122. In an alternative embodiment, the engagement portion 134 may be adapted for attachment to the structural member so that a tensile force is applied when the bolt 134 is turned so as to withdraw the engagement portion toward the lever arm bore 122. In yet another alternative, the engagement portion 134 may be configured for attachment of a hook or nut after it has been passed through a hole in or adjacent an edge of the structural member so that a tensile force may be applied to the structural member.

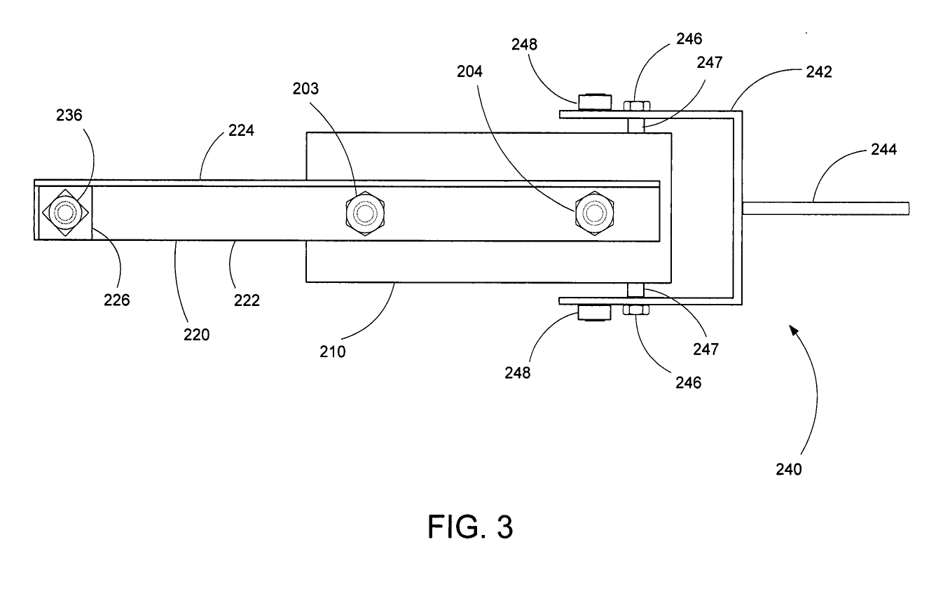

With reference to FIGS. 3-5, an adjustment device 200 according to an embodiment of the invention that has a lighter weight lever arm. The adjustment device 200 includes an attachment body 210 that is substantially similar to that of the previous discussed embodiment, a lever arm 220 and a jacking arrangement 230. The lever arm 220 has an L-shaped cross-section with a base member 222 and an orthogonal upright member 224. As with the earlier embodiment, the lever arm 220 is attached to the attachment body 210 by a pair of threaded fasteners 203, 204 and extends laterally outward from the attachment body 210. The jacking arrangement 230 is disposed at the free end of the lever arm 220. As shown, the jacking arrangement 230 may comprise a jacking bolt 232 having a head 236 and an engagement end 234. A boss 226 is formed on or attached to the lever arm 220. The boss 226 has a threaded bore 228 adapted to receive the bolt 232. The L-shaped lever arm 220 may be formed from any suitable structural material. Its shape provides the required strength while significantly reducing the weight of the adjustment device.

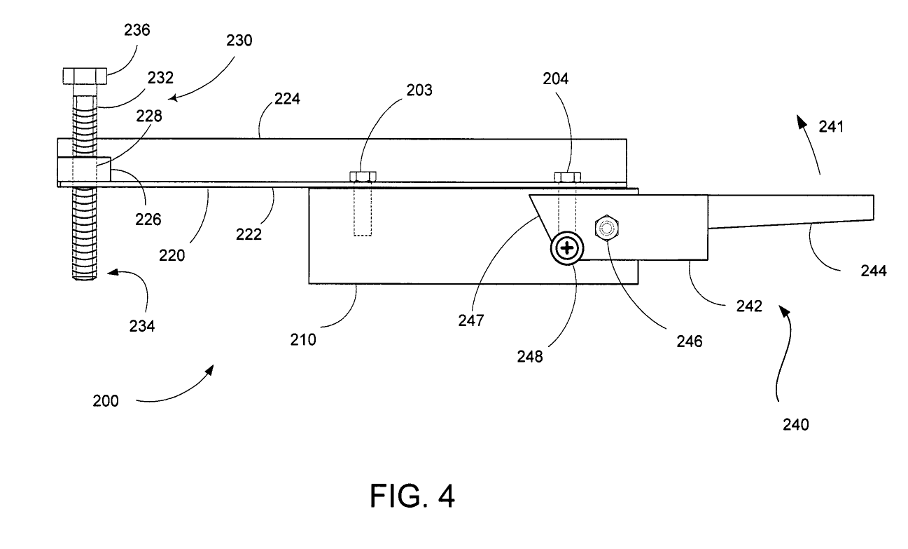

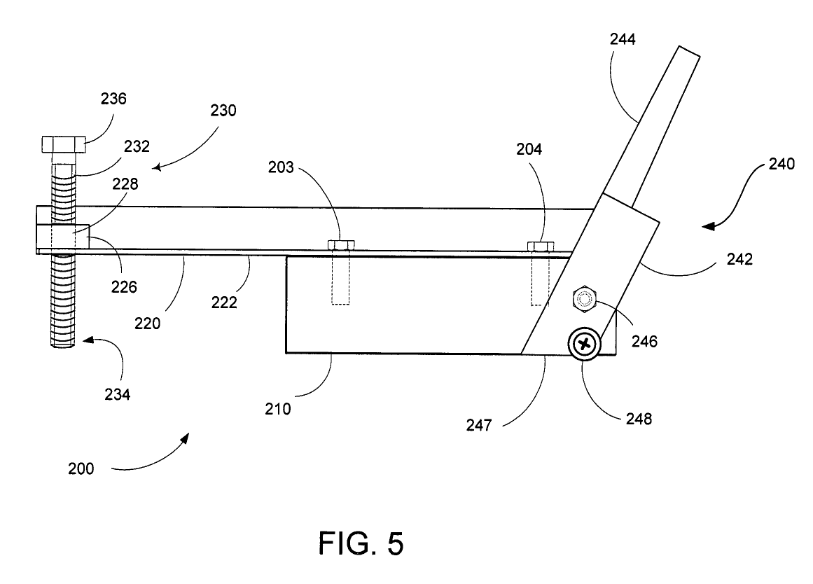

As shown in FIGS. 4-6, the adjustment devices of the invention may optionally include a detachment arrangement 240 configured to assist in removing the adjustment device from a structural member to which it has been magnetically attached. The detachment arrangement 240 includes a handle 244 attached to a bracket 242 that is pivotally attached to the attachment body 210 by a pivot 246. Rollers 248 are attached to the bracket on opposite sides of the attachment body 210. The rollers 248 are positioned so that they extend past the edge 247 of the bracket 242 opposite the handle 244. FIGS. 4 and 5 illustrate the detachment arrangement 240 in its attachment position (i.e., the position it is in when the attachment body 210 is attached to a structural body. The bracket 240 and rollers 248 are configured so that when the handles 244 is rotated in the direction 241, the rollers 248 will contact the surface of the structural member to which the device is attached. Further rotation of the handle 244 causes the attachment body 210 to be forced away from the surface of the structural member. The handle 244 and the bracket 242 are configured to provide substantial leverage to allow a user to overcome the magnetic force between the attachment body 210 and the structural member.

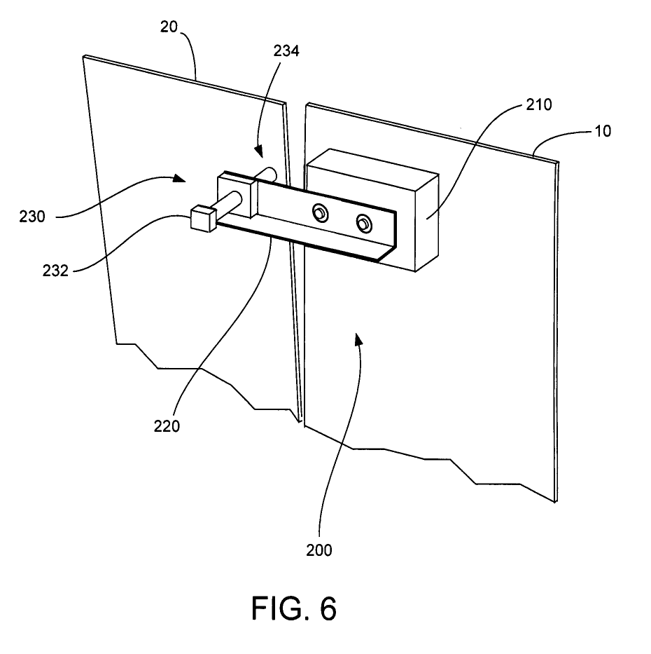

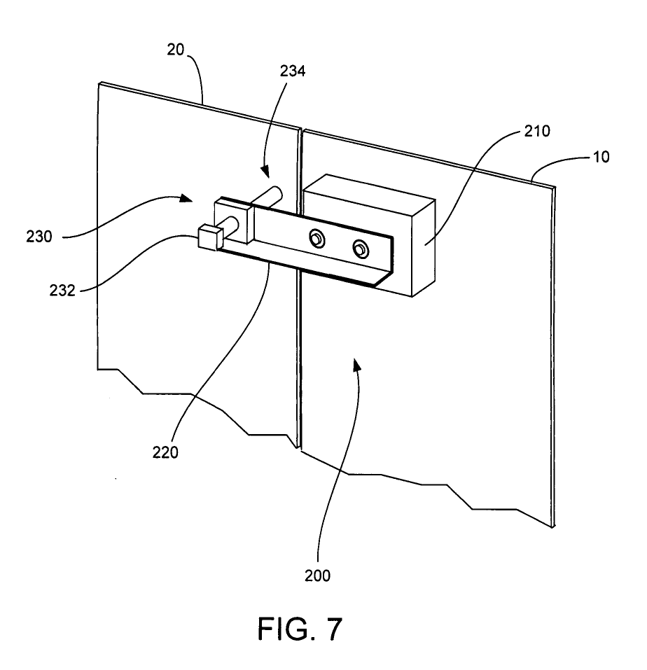

FIGS. 6 and 7 illustrate the use of the adjustment devices of the invention. The adjustment device 200 is used for example purposes and is shown without the optional detachment arrangement 240. In the example shown, the adjustment device 200 is used to align a second planar structural member 20 with a first planar structural member 10. FIG. 6 shows the structural members 10, 20 in their initial unaligned positions. For purposes of this example, it is assumed that a portion (not shown) of each of the structural members 10, 20 is fixed or held in some way and that the illustrated portions require alignment. To accomplish this alignment, the attachment body 210 is placed against the surface of the first structural member 10 so that it is held in place by magnetic force. The attachment body 210 is positioned so that the lever arm 220 extends over a portion of the second structural member 20. The jacking bolt 232 is then rotated so as to cause the engagement end 234 of the bolt 232 to engage the surface of the second structural member 20. The jacking bolt 232 is then further turned to apply a compressive force to the surface of the second structural member 20. As sufficient force is applied, a portion of the second structural member 20 is forced to move relative to the first structural member 10. The user continues to turn the jacking bolt 232 until the two structural members 10, 20 are aligned as shown in FIG. 7.

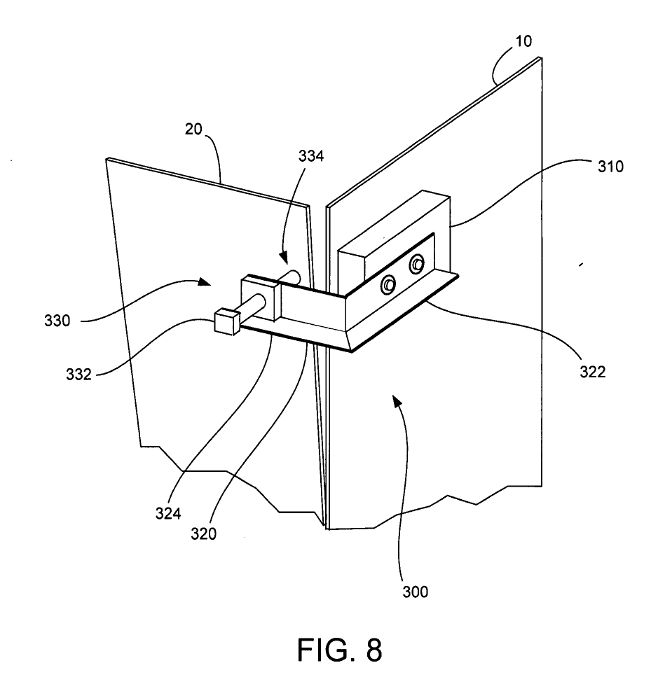

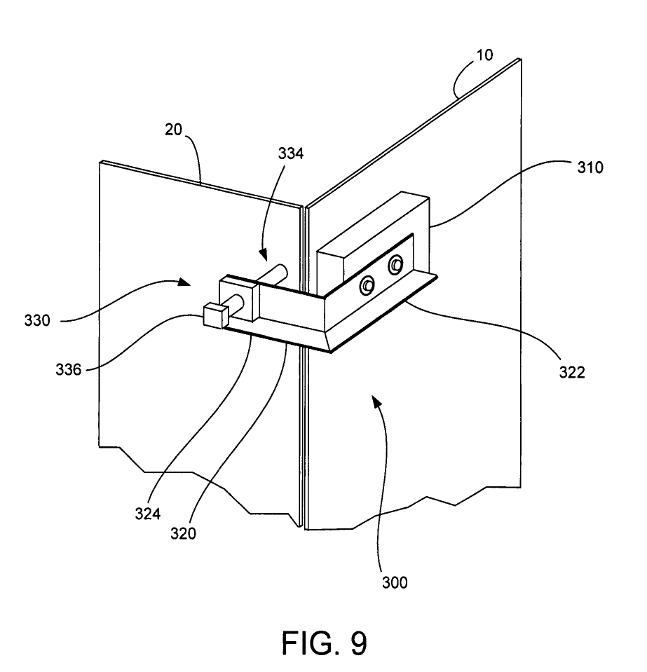

FIGS. 8 and 9 illustrate an adjustment device 300 that is configured for adjustment of the relative position of structural members that are not parallel or near parallel. The adjustment device 300 includes an attachment body 310 that is substantially similar to that of the previous embodiments, a lever arm 320 and a jacking arrangement 330. In this embodiment, the lever arm 320 is configured to adjust the relative position of a first structural member 10 and a second structural member that are intended to form a 90 degree corner. Accordingly, the lever arm 320 has a first portion 322 that is attached to the attachment body 310 and a second portion 324 that forms a right angle with the first portion. A jacking arrangement 330 similar to that of the adjustment device 200 of FIGS. 3-5 is attached to the second portion 324 adjacent its free end. As shown in FIG. 8, which shows the structural members 10, 20 in an unaligned position, the attachment block 310 is attached to the first structural member 10 and positioned so that the second lever arm portion 324 extends over the surface of the second structural member 20. The jacking bolt 336 can then be used to apply a compressive force to second structural member 20 to cause at least a portion of the second structural member to move relative to the first structural member 10. By continuing to turn the bolt 336, the two structural members are adjusted to the position shown in FIG. 9.

It will be understood by those of ordinary skill in the art that the lever arm may be configured for alignment at any angle. Further, the lever arm 320 may be configured to allow angle adjustment between the first and second lever arm portions 322, 324 to allow the use of a single device to provide multiple alignment angles. It will also be understood that in this embodiment, the attachment body 310 must be configured to provide a sufficient shear force to counter the jacking force component directed laterally relative to the surface of the first structural member.

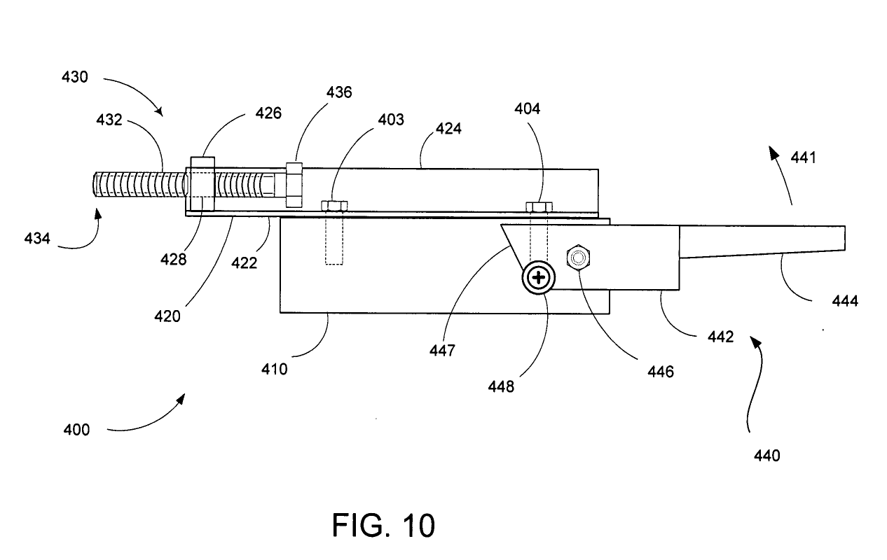

FIG. 10 illustrates an adjustment device 400 according to an embodiment of the invention. The device 400 provides another approach to aligning members at a corner. In this case, the device 400 is attachable on the inside of the intended corner rather than the outside. The adjustment device 400 includes an attachment body 410 that is substantially similar to that of the previous discussed embodiments, a lever arm 420 and a jacking arrangement 430. The lever arm 420 has an L-shaped cross-section with a base member 422 and an orthogonal upright member 424. The lever arm 420 is attached to the attachment body 410 by a pair of threaded fasteners 403, 404 and extends laterally outward from the attachment body 410. The jacking arrangement 430 is disposed at the free end of the lever arm 420. As shown, the jacking arrangement 430 may comprise a jacking bolt 432 having a head 436 and an engagement end 434. A boss 426 is formed on or attached to the lever arm 420. The boss 426 has a threaded bore 428 adapted to receive the bolt 432. The L-shaped lever arm 420 may be formed from any suitable structural material and provides the required strength while significantly reducing the weight of the adjustment device over a solid member. It will be understood, however, that the lever arm 420 may be formed in any configuration and from any material that will provide the requisite leverage and strength.

As shown in FIG. 10, the adjustment device of the invention may optionally include a detachment arrangement 440 configured to assist in removing the adjustment device from a structural member to which it has been magnetically attached. The detachment arrangement 440 is substantially similar to that shown in FIGS. 3 and 4 and includes a handle 444 attached to a bracket 442 that is pivotally attached to the attachment body 410 by a pivot 446. Rollers 448 are attached to the bracket on opposite sides of the attachment body 410. The rollers 448 are positioned so that they extend past the edge 447 of the bracket 442 opposite the handle 444. FIG. 10 illustrates the detachment arrangement 440 in its attachment position (i.e., the position it is in when the attachment body 410 is attached to a structural body. The bracket 440 and rollers 448 are configured so that when the handles 444 is rotated in the direction 441, the rollers 448 will contact the surface of the structural member to which the device is attached. Further rotation of the handle 444 causes the attachment body 410 to be forced away from the surface of the structural member. The handle 444 and the bracket 442 are configured to provide substantial leverage to allow a user to overcome the magnetic force between the attachment body 410 and the structural member. member.

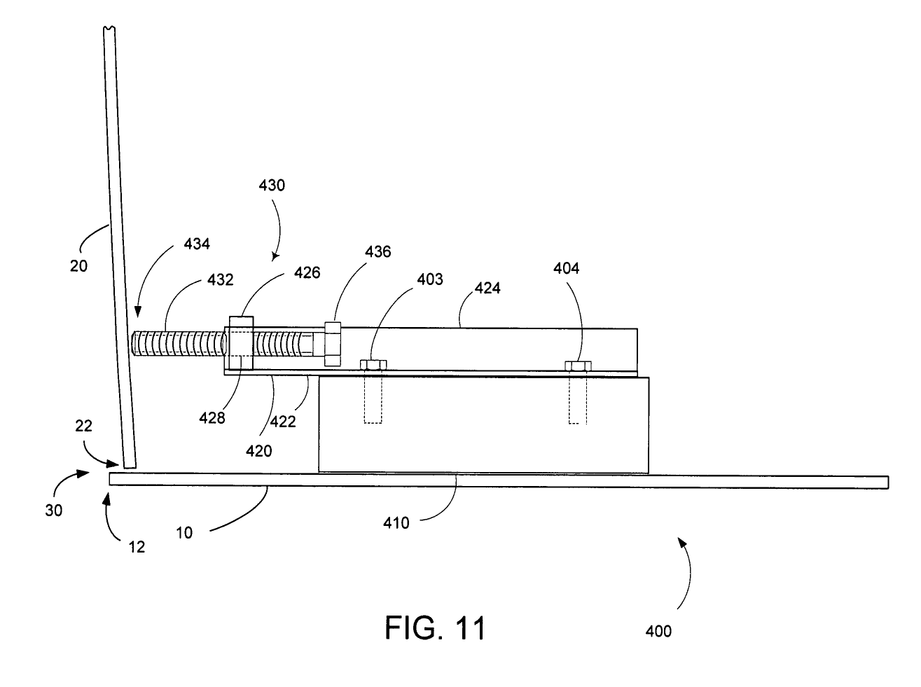

FIG. 11 illustrates an exemplary use of the adjustment device 400, which is illustrated without the optional detachment arrangement 440. In the example shown, the adjustment device 400 is being used to align an edge 22 of a second planar structural member 20 with an edge 12 of a first planar structural member 10. FIG. 11 shows the structural members 10, 20 in their initial unaligned positions. For purposes of this example, it is assumed that a portion (not shown) of each of the structural members 10, 20 is fixed or held in some way and that the illustrated portions require alignment. To accomplish this alignment, the attachment body 410 is placed against the inside surface of the first structural member 10 so that it is held in place by magnetic force. The attachment body 410 is positioned so that the lever arm 420 extends toward the second structural member 20. Once in the illustrated position, the jacking bolt 432 may be rotated so as to cause the engagement end 434 of the bolt 432 to engage the surface of the second structural member 20. The jacking bolt 432 may then be further turned to apply a force to the surface of the second structural member 20. As sufficient force is applied, a portion of the second structural member 20 is forced to move relative to the first structural member 10. The user may continue to turn the jacking bolt 432 until the edges 12, 22 of the two structural members 10, 20 are aligned to form a corner at 30.

In the example described above, the adjustment device 400 is used to push a portion of a second structural member 20 into alignment with a first member 10. The device 400 may also be used to pull a portion of the second structural member 20 into alignment by providing a mechanism (not shown) for attaching the engagement end 434 to the second structural member. This may also be accomplished by providing a mechanism that allows the jacking bolt 432 to apply a force to the opposite side of the second structural member 20. For example, if the jacking bolt 432 is passed through a hole in the second structural member, 20, a nut or other device with a diameter larger than that of the hole may be threaded onto the jacking bolt 432. Withdrawing the jacking bolt 432 toward the attachment body 420 would cause a portion of the second structural member 20 to be pulled toward the engagement body 420.

Any of the adjustment devices of the invention may be provided with more than one lever arm. For example two or more lever arms may be attached to a single attachment body with each lever arm extending in the same lateral direction. Alternatively, multiple lever arms may extend at different angles in a plane parallel or nearly parallel to the engagement surface of the attachment body. Yet another alternative is to have one lever arm that is parallel to or near parallel to the engagement surface while one or more other lever arms are attached to a different surface of the attachment body such that they extend outward in a plane that is not parallel to the engagement surface.

It will be understood that the adjustment devices of the invention allow structural members to be quickly and easily positioned so that they can be joined together and that the device can then be quickly and easily removed. It can also be seen that multiple devices can be used to align large structures such as plates for attachment to one another.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

What is claimed is:

1. A device for positioning a first structural member relative to a second structural member, the second structural member being attractable to a magnetic material, the device comprising:
a body comprising the magnetic material and having an engagement surface adapted for engagement with and magnetic attachment to a surface of the second structural member;
an elongate lever arm having a first lever arm end connected to the body and a second lever arm end extending laterally outward therefrom; and
a jacking arrangement attached to the second lever arm end, the jacking arrangement having an engagement member adapted for selectively engaging and applying a force to the first structural member to move at least a portion of the first structural member relative to the surface of the second structural member.

2. A device according to claim 1 wherein the jacking arrangement comprises a threaded bore through the lever arm adjacent the second lever arm end and the engagement member is a threaded bolt disposed through the threaded bore and having an engagement end adapted for engaging the first structural member and a head end adapted for selectively turning the threaded bolt to advance or withdraw the engagement end.

3. A device according to claim 1 wherein the lever arm is formed as an L-shaped member having a base portion attached to the attachment body and an upright portion, wherein the device further comprises a boss attached to the base portion adjacent the second lever arm end, the boss having a threaded bore formed therethrough, and wherein the engagement member is a threaded bolt disposed through the threaded bore and having an engagement end adapted for engaging the first structural member and a head end adapted for selectively turning the threaded bolt to advance or withdraw the engagement end.

4. A device according to claim 1 wherein the lever arm has a first portion that is attached to the attachment block and that has a first free end extending laterally outward from the attachment block and a second portion attached to the first portion at the first free end, the first portion having a first arm axis and the second portion having a second axis that is at an alignment angle from the first arm axis.

5. A device according to claim 1 wherein the attachment body comprises a block of the magnetic material, the engagement surface being formed thereon.

6. A device according to claim 1 wherein the attachment body is a laminate structure having a magnetic layer formed from the magnetic material.

7. A device according to claim 1 wherein the engagement surface has a surface shape adapted to conform to a surface shape of the second structural member.

8. A device according to claim 1 wherein the engagement surface may be adjusted to conform to a surface shape of the second structural member.

9. A device according to claim 1 further comprising detachment means for selectively detaching the attachment block from a surface to which the attachment block is magnetically attached.

10. A device according to claim 1 further comprising a detachment arrangement attached to the attachment block, the detachment arrangement comprising a bracket pivotally attached to the attachment block and rollers attached to the bracket, the bracket being configured so that rotation of the bracket in a predetermined direction when the attachment body is engaging a surface causes the rollers to engage the surface and so that further rotation of the bracket causes the attachment block to disengage from the surface.

11. A device according to claim 1 wherein the lever arm and the jacking arrangement are configured so that the force applied by the engagement member is directed perpendicular to the engagement surface.

12. A device according to claim 1 wherein the lever arm and the jacking arrangement are configured so that the force applied by the engagement member is directed parallel to the engagement surface.

13. A device according to claim 1 wherein a first portion of the elongate lever arm extends parallel to the engagement surface of the body comprising the magnetic material, a second portion of the elongate lever arm extends at an angle other than parallel to the engagement surface and the jacking arrangement is configured so that the force applied by the engagement member is directed at an angle other than perpendicular or parallel to the engagement surface.

14. A device according to claim 1 wherein the body comprises an electromagnet.

15. A method of positioning a first structural member relative to a second structural member, the second structural member being attractable to a magnetic material, the method comprising:
providing an adjustment device comprising a magnetic body having an engagement surface adapted for engagement with and magnetic attachment to a surface of the second structural member, a lever arm having a first lever arm end connected to the body and a second lever arm end extending laterally therefrom, and a jacking arrangement attached to the second lever arm end, the jacking arrangement having an engagement member that may be selectively extended to engage and apply a force to the first structural member;
magnetically attaching the adjustment device to the second structural member by placing the engagement surface in engagement with the surface of the second structural member;
positioning and orienting the adjustment device so that the second lever arm end extends over a surface of the first structural member and so that the engagement member is in a position to engage the surface of the second structural member when extended;
extending the engagement member to engage the surface of the first structural member; and
further extending the engagement member to apply a force to the first structural member sufficient to cause the relative position of at least a portion of the first structural member to change relative to at least a portion of the second structural member.

16. A method according to claim 15 wherein the action of further extending the engagement member is continued until a predetermined relative orientation of the first and second structural members is achieved.

17. A method according to claim 15 further comprising:
detaching the adjustment device from the second structural member.
